(19) United States
(12) Patent Application Publication
(10) Pub. No.: US 2024/0069365 A1
(43) Pub. Date: Feb. 29, 2024

(54) Eyeglass Location Assembly

(71) Applicant: Benjamin Hackney, Bridgeton, MO (US)

(72) Inventor: Benjamin Hackney, Bridgeton, MO (US)

(21) Appl. No.: 17/894,859

(22) Filed: Aug. 24, 2022

(51) Int. Cl. G02C 11/00; G01S 19/14; G08B 3/10

(52) U.S. Cl. CPC G02C 11/10; G01S 19/14; G08B 3/1016

(57) ABSTRACT

An eyeglass location assembly for locating lost eyeglasses includes a pair of eyeglasses that are wearable on a user for vision correction. A tracking unit is integrated into the eyeglasses, the tracking unit broadcasts a locate signal when the tracking unit is actuated and the tracking unit emits an alarm when the tracking unit is actuated. A key fob is in remote communication with the tracking unit and the key fob broadcasts an actuate signal when the key fob is actuated. The tracking unit emits the alarm when the key fob broadcasts the actuate signal to facilitate a user to locate the eyeglasses. A personal electronic device stories a location application and the personal electronic device is in wireless communication with the tracking unit. The personal electronic device displays the physical location of the eyeglasses on a map to facilitate the user to locate the eyeglasses.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to location devices and more particularly pertains to a new location device for locating lost eyeglasses. The device includes a pair of eyeglasses and a tracking unit integrated into the eyeglasses. The device includes a key fob that is in remote communication with the tracking unit and the tracking unit it turned on when the key fob is actuated. The tracking unit emits an audible alarm when the key fob is actuated to facilitate a user to locate the eyeglasses. Additionally, a personal electronic device is provided which is in wireless communication with the tracking unit. The tracking unit is in communication with a global positioning system and the tracking unit communicates a physical location of the eyeglasses to the personal electronic device thereby facilitating the personal electronic device to display the physical location of the eyeglasses.

### (2) Description of Related Art Including Information Disclosed Under 37 CFR 1.97 and 1.98

The prior art relates to location devices including a variety of object location devices that includes a plurality of locators that can be attached to respective objects and a communication unit that is in communication with each of the locators. The prior art discloses an object location device that includes a pair of locators that are each attachable to a respective object and which are in communication with each other for emitting an audible alert when an opposing locator is actuated. The prior art discloses a wireless communication device that is integrated into a pair of eyeglasses and which is in communication with a personal electronic device for sending and receiving wireless signals.

### BRIEF SUMMARY OF THE INVENTION

An embodiment of the disclosure meets the needs presented above by generally comprising a pair of eyeglasses that are wearable on a user for vision correction. A tracking unit is integrated into the eyeglasses, the tracking unit broadcasts a locate signal when the tracking unit is actuated and the tracking unit emits an alarm when the tracking unit is actuated. A key fob is in remote communication with the tracking unit and the key fob broadcasts an actuate signal when the key fob is actuated. The tracking unit emits the alarm when the key fob broadcasts the actuate signal to facilitate a user to locate the eyeglasses. A personal electronic device stories a location application and the personal electronic device is in wireless communication with the tracking unit. The personal electronic device displays the physical location of the eyeglasses on a map to facilitate the user to locate the eyeglasses.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an eyeglass location assembly according to an embodiment of the disclosure.

FIG. 2 is a perspective in-use view of an embodiment of the disclosure.

FIG. 3 is a schematic view of an embodiment of the disclosure.

### DETAILED DESCRIPTION OF THE INVENTION

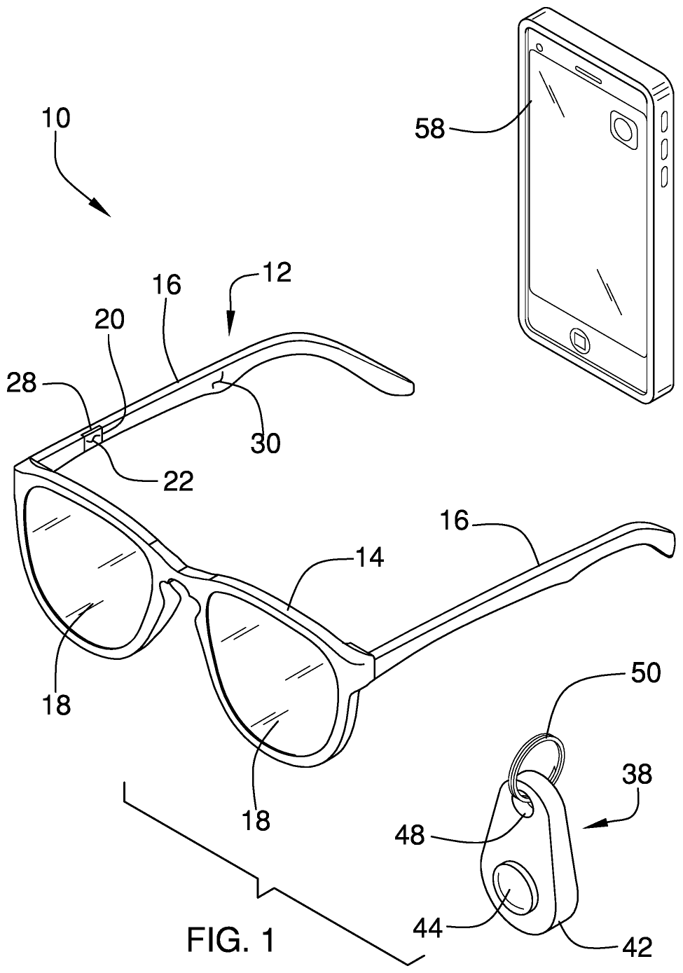

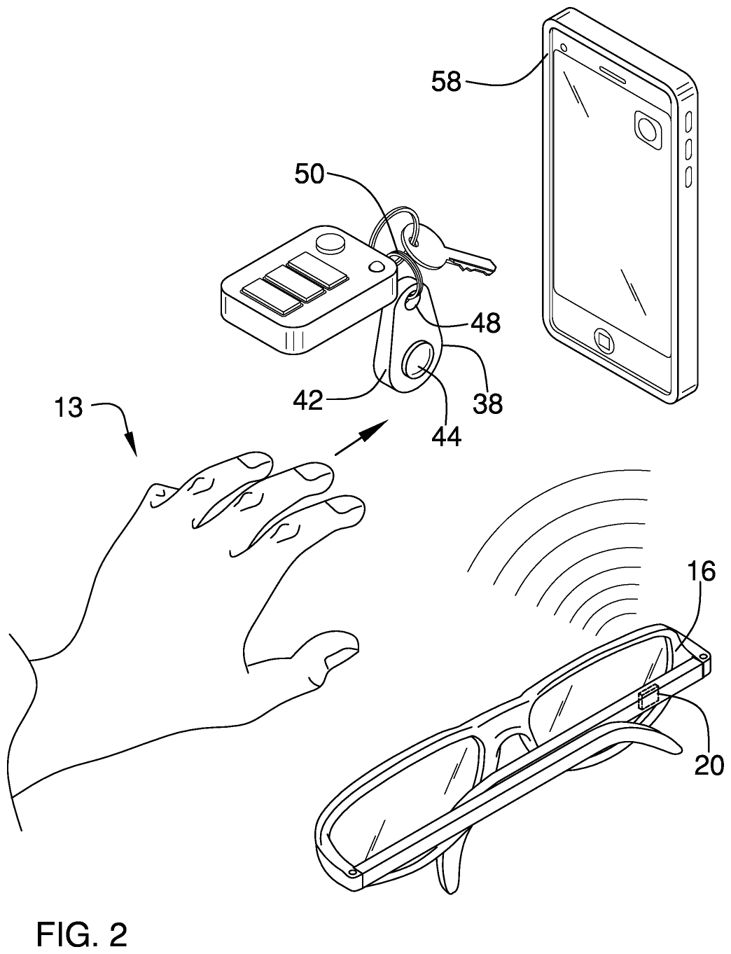

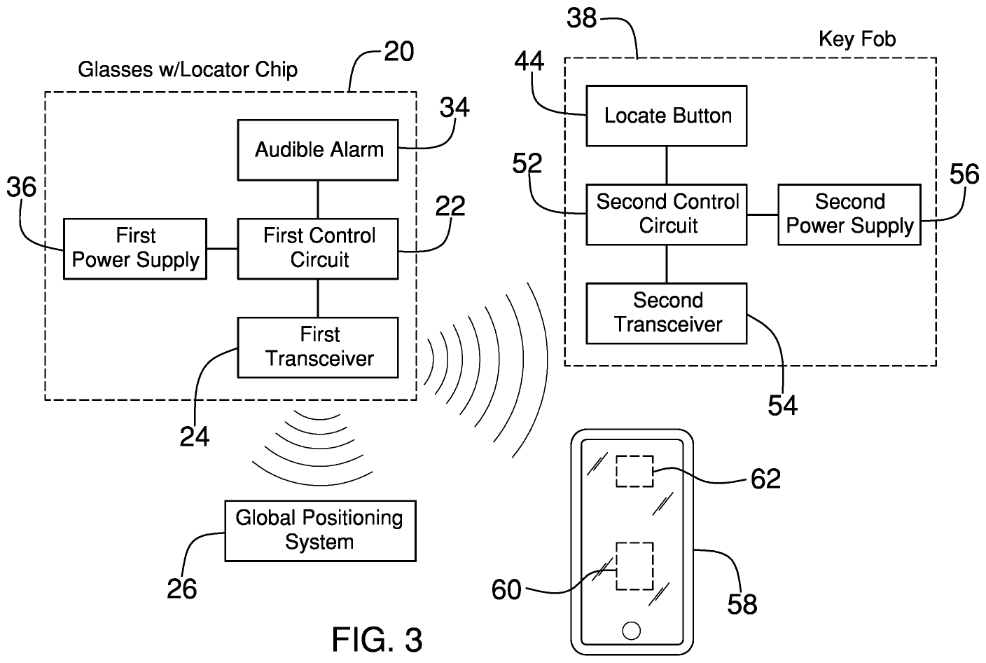

With reference now to the drawings, and in particular to FIGS. 1 through 3 thereof, a new location device embodying the principles and concepts of an embodiment of the disclosure and generally designated by the reference numeral 10 will be described.

As best illustrated in FIGS. 1 through 3, the eyeglass location assembly 10 generally comprises a pair of eyeglasses 12 that is wearable on a user 13 for vision correction. The pair of eyeglasses 12 has a frame 14, a pair of arms 16 each being hingedly coupled to the frame 14 and a pair of lenses 18. The eyeglasses 12 may comprise corrective eyeglasses, sunglasses or any other type of eyeglasses. A tracking unit 20 is integrated into the eyeglasses 12 and the tracking unit 20 broadcasts a locate signal when the tracking unit 20 is actuated. Additionally, the tracking unit 20 emits an alarm when the tracking unit 20 is actuated.

The tracking unit 20 comprises a first control circuit 22 that is integrated into a respective one of the arms 16 of the eyeglasses 12 and the first control circuit 22 receives a locate input. The tracking unit 20 includes a first transceiver 24 that is integrated into the respective arm 16 and the first transceiver 24 is electrically coupled to the first control circuit 22. Additionally, the first transceiver 24 is in remote communication with a global positioning system 26 thereby facilitating the first transceiver 24 to identify the physical location of the eyeglasses 12. The first transceiver 24 broadcasts the locate signal when the first control circuit 22 receives the locate input. Furthermore, the first transceiver 24 may comprise a radio frequency transceiver or the like and the first transceiver 24 may employ Bluetooth communication protocols. As is most clearly shown in FIG. 1, the respective arm 16 may have a recess 28 integrated into an inner surface 30 of the respective arm 16 and the tracking unit 20 may be positioned in the recess 28. Furthermore, an outer surface 32 of the tracking unit 20 may lie flush with the inner surface 30 of the respective arm 16.

The tracking unit 20 includes an alarm 34 that is integrated into the respective arm 16 and the alarm 34 is electrically coupled to the first control circuit 22. The alarm 34 is turned on when the first control circuit 22 receives the locate input and the alarm 34 emits an audible alert when the alarm 34 is turned on. In this way the alarm 34 facilitates the user 13 to locate the eyeglasses 12 via sound. The alarm 34 may comprise a miniaturized speaker, such as a piezoelectric speaker or the like. The tracking unit 20 includes a first power supply 36 that is integrated into the respective arm 16 and the first power supply 36 is electrically coupled to the first control circuit 22. Additionally, the first power supply 36 is electrically coupled to the first control circuit 22 and the first power supply 36 comprises at least one battery.

A key fob 38 is provided which is in remote communication with the tracking unit and the key fob 38 broadcasts an actuate signal when the key fob 38 is actuated. The tracking unit 20 emits the alarm when the key fob 38 broadcasts the actuate signal to facilitate a user 13 to locate the eyeglasses 12. Furthermore, the tracking unit 20 broadcasts the locate signal when the key fob 38 broadcasts the actuate signal. The key fob 38 includes a housing 42 that has an actuate button 44 which is movably integrated into an outer wall 46 of the housing 42. The housing 42 has a hole 48 extending through the housing 42 and a key ring 50 extends through the hole 48. In this way the key ring 50 can be attached to a set of car keys, for example, or other keys that the user 13 would commonly carry with them.

A second control circuit 52 is integrated into the housing 42 of the key fob 38 and the second control circuit 52 is electrically coupled to the actuate button 44. Furthermore, the second control circuit 52 receives an actuate input when the actuate button 44 is depressed. A second transceiver 54 is integrated into the housing 42 of the key fob 38 and the second transceiver 54 is electrically coupled to the second control circuit 52. The second transceiver 54 broadcasts the actuate signal when the second control circuit 52 receives the actuate input. Additionally, a second power supply 56 is integrated into the housing 42, the second power supply 56 is electrically coupled to the second control circuit 52 and the second power supply 56 comprises at least one battery.

A personal electronic device 58 is provided which stores a location application 60. The personal electronic device 58 is in wireless communication with the tracking unit 20 and the personal electronic device 58 receives the locate signal from the tracking unit 20. Furthermore, the location application 60 processes the locate signal thereby facilitating the location application 60 to display the physical location of the eyeglasses 12 on a map. In this way the personal electronic device 58 facilitates the user 13 to locate the eyeglasses 12.

The personal electronic device 58 may comprise a smart phone or the like and the location application may comprise a global positioning system navigation application or other similar application that can display the physical location of the tracking unit 20 in reference to the location of the personal electronic device 58. The personal electronic device 58 includes a third transceiver 62 that is in wireless communication with the first transceiver 24. The third transceiver 62 receives the locate signal from the first transceiver 24, the third transceiver 62 may comprise a radio frequency transceiver or the like and the third transceiver 62 may employ Bluetooth communication protocols.

In use, the actuate button 44 on the key fob 38 is depressed when the eyeglasses 12 have been lost or misplaced. In this way the alarm 34 is actuated to emit the audible alarm 34 to facilitate the eyeglasses 12 to be located via audile sound. Additionally, the personal electronic device 58 can be employed to locate the eyeglasses 12 when the eyeglasses 12 are too far away for the user 13 to hear the audible sound. In this way the eyeglasses 12 can be located regardless of where the eyeglasses 12 are located.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An eyeglass location assembly for locating misplaced eyeglasses, said assembly comprising:
a pair of eyeglasses being wearable on a user for vision correction;
a tracking unit being integrated into said eyeglasses, said tracking unit broadcasting a locate signal when said tracking unit is actuated, said tracking unit emitting an alarm when said tracking unit is actuated;
a key fob being in remote communication with said tracking unit, said key fob broadcasting an actuate signal when said key fob is actuated, said tracking unit emitting said alarm when said key fob broadcasts said actuate signal wherein said key fob is configured to facilitate a user to locate said eyeglasses, said tracking unit broadcasting said locate signal when said key fob broadcasts said actuate signal; and
a personal electronic device storing a location application, said personal electronic device being in wireless communication with said tracking unit, said personal electronic device receiving said locate signal from said tracking unit, said location application processing said locate signal thereby facilitating said location application to display the physical location of said eyeglasses on a map wherein said personal electronic device is configured to facilitate the user to locate said eyeglasses.

2. The assembly according to claim 1, wherein:
said pair of eyeglasses having a frame, a pair of arms each being hingedly coupled to said frame and a pair of lenses;
said tracking unit comprises:
a first control circuit being integrated into a respective one of said arms of said eyeglasses, said first control circuit receiving a locate input;
a first transceiver being integrated into said respective arm, said first transceiver being electrically coupled to said first control circuit, said first transceiver being in remote communication with a global positioning system thereby facilitating said first transceiver to identify the physical location of said eyeglasses, said first transceiver broadcasting said locate signal when said first control circuit receives said locate input;
an alarm being integrated into said respective arm, said alarm being electrically coupled to said first control circuit, said alarm being turned on when said first control circuit receives said locate input, said alarm emitting an audible alert when said alarm is turned on wherein said alarm is configured to facilitate the user to locate said eyeglasses via sound; and
a first power supply being integrated into said respective arm, said first power supply being electrically coupled to said first control circuit, said first power supply comprising at least one battery.

3. The assembly according to claim 2, wherein said key fob includes:
a housing having an actuate button being movably integrated into an outer wall of said housing;
a second control circuit being integrated into said housing, said second control circuit being electrically coupled to said actuate button, said second control circuit receiving an actuate input when said actuate button is depressed;
a second transceiver being integrated into said housing, said second transceiver being electrically coupled to said second control circuit, said second transceiver broadcasting said actuate signal when said second control circuit receives said actuate input; and
a second power supply being integrated into said housing, said second power supply being electrically coupled to said second control circuit, said second power supply comprising at least one battery.

4. The assembly according to claim 2, wherein said personal electronic device includes a third transceiver being in wireless communication with said first transceiver, said third transceiver receiving said locate signal from said first transceiver.

5. An eyeglass location assembly for locating misplaced eyeglasses, said assembly comprising:
a pair of eyeglasses being wearable on a user for vision correction, said pair of eyeglasses having a frame, a pair of arms each being hingedly coupled to said frame and a pair of lenses;
a tracking unit being integrated into said eyeglasses, said tracking unit broadcasting a locate signal when said tracking unit is actuated, said tracking unit emitting an alarm when said tracking unit is actuated, said tracking unit comprising:
a first control circuit being integrated into a respective one of said arms of said eyeglasses, said first control circuit receiving a locate input;
a first transceiver being integrated into said respective arm, said first transceiver being electrically coupled to said first control circuit, said first transceiver being in remote communication with a global positioning system thereby facilitating said first transceiver to identify the physical location of said eyeglasses, said first transceiver broadcasting said locate signal when said first control circuit receives said locate input;
an alarm being integrated into said respective arm, said alarm being electrically coupled to said first control circuit, said alarm being turned on when said first control circuit receives said locate input, said alarm emitting an audible alert when said alarm is turned on wherein said alarm is configured to facilitate the user to locate said eyeglasses via sound; and
a first power supply being integrated into said respective arm, said first power supply being electrically coupled to said first control circuit, said first power supply comprising at least one battery;
a key fob being in remote communication with said tracking unit, said key fob broadcasting an actuate signal when said key fob is actuated, said tracking unit emitting said alarm when said key fob broadcasts said actuate signal wherein said key fob is configured to facilitate a user to locate said eyeglasses, said tracking unit broadcasting said locate signal when said key fob broadcasts said actuate signal, said key fob including:
a housing having an actuate button being movably integrated into an outer wall of said housing;
a second control circuit being integrated into said housing, said second control circuit being electrically coupled to said actuate button, said second control circuit receiving an actuate input when said actuate button is depressed;
a second transceiver being integrated into said housing, said second transceiver being electrically coupled to said second control circuit, said second transceiver broadcasting said actuate signal when said second control circuit receives said actuate input; and
a second power supply being integrated into said housing, said second power supply being electrically coupled to said second control circuit, said second power supply comprising at least one battery;
a personal electronic device storing a location application, said personal electronic device being in wireless communication with said tracking unit, said personal electronic device receiving said locate signal from said tracking unit, said location application processing said locate signal thereby facilitating said location application to display the physical location of said eyeglasses on a map wherein said personal electronic device is configured to facilitate the user to locate said eyeglasses, said personal electronic device including a third transceiver being in wireless communication with said first transceiver, said third transceiver receiving said locate signal from said first transceiver.
